(19) United States
(12) Patent Application Publication
(10) Pub. No.: US 2002/0049724 A1
(43) Pub. Date: Apr. 25, 2002

(54) Information publicizing system and information publicizing method

(76) Inventors: Keiichiro Matsuzawa, Tokyo (JP); Hiroshi Takada, Tokyo (JP)

Correspondence Address: RABIN & CHAMPAGNE, PC, 1101 14TH STREET, NW, SUITE 500, WASHINGTON, DC, 20005, US

(21) Appl. No.: 09/855,760

(22) Filed: May 16, 2001

(30) Foreign Application Priority Data
May 17, 2000 (JP) 144912/2000
May 11, 2001 (JP) 141694/2001

(51) Int. Cl. G06F 7/00

(52) U.S. Cl. 707/1

(57) ABSTRACT

The invention aims at making it possible to quickly publicize data from a system having a different purpose for another purpose.

An information publicizing system comprising couplers respectively connected to systems each of which processes data for its purpose and a publicizing management system which is connected to said couplers and keeps data to be publicized, wherein said couplers have means for converting data dealt with in the respective systems into data of a specified common form and means for sending the converted data to said publicizing management system, and said publicizing management system has a means for producing data to be publicized on the basis of the received data.

### BACKGROUND OF THE INVENTION

1. Field of the Invention

The present invention relates to an information publicizing system, and more particularly to an information publicizing system and information publicizing method making it possible to publicize necessary data out of data dealt with in a plurality of systems having different purposes and data of messages, comments and the like related to said necessary data.

2. Prior Art

Data are interchanged between companies using an EDI (Electronic Data Interchange) system and the like. Transaction data such as purchase data, order reception data, ordering data and the like are transferred in a data format common to companies through a leased line or a VAN (Value Added Network), and are taken into an in-house work processing system or the like to be processed. By this, an electronic data interchange is performed without using a paper slip or the like and an information exchange is made higher in speed and the amount of man-hour for office work is reduced.

And on the other hand, services of issuing information by displaying information of commodities, events and the like on Web sites on the Internet are performed.

Since an existing EDI system depends upon application software specific to the EDI system, however, it is not easy to provide its data to a system other than the EDI system or to open its data to a third party. For example, this is such a case that data of various EDI systems are collected and only necessary data selected from the collected data are collectively publicized on another system.

Such a case is not limited to only EDI systems but is the same also in case of publicizing data utilized in various different information networks in order to utilize those data for various purposes. Up to now, in talent information networks, commodities transactions networks or the like which have been built by various companies, even in case that a transaction has not succeeded as a result of searching on one network but may succeed on another network, data for searching for a customer are not opened. Therefore, it has been necessary to individually search for customers by means of other means such as a telephone and the like.

Further, there has not been also a system for collecting and publicizing only necessary data among computer systems having different purposes. For example, when a disaster has occurred in some area, the persons concerned in disaster recovery and the general public have a demand of grasping various information at any time but such information is not collectively publicized, and therefore it has been necessary to obtain traffic information, weather information, disaster relief information and the like from individual computer systems such as a traffic information system, a weather information system and the like, and as the result it has not been possible to quickly collect such information.

### SUMMARY OF THE INVENTION

The present invention has been performed in order to solve such a problem and aims at making it possible to publicize data utilized in systems having various purposes and such data as messages and the like related to those data for other purposes.

For such a purpose as this, the present invention provides an information publicizing system comprising couplers connected to systems each of which processes data for its purpose and a publicizing management system which is connected to the couplers and keeps data to be publicized, wherein the couplers have means for converting data dealt with in the respective systems into data of a specified common form and have means for sending the converted data to the publicizing management system, and the publicizing management system has a means for producing data to be publicized on the basis of the received data.

### BRIEF DESCRIPTION OF THE DRAWINGS

FIG. 1 shows an example of the composition of an EDI system being an embodiment of the present invention.

FIG. 2 shows an example of the composition of an information publicizing system being an embodiment of the present invention.

FIG. 3 shows an example of the composition of a coupler 4.

FIG. 4 shows schematically contents of databases DBm and DBk.

FIG. 5 shows an example of an excess articles site screen.

FIG. 6 shows an example of a disaster information site screen.

FIG. 7 shows an example of a screen changed over by clicking a road information button.

### DETAILED DESCRIPTION OF THE PREFERRED EMBODIMENTS

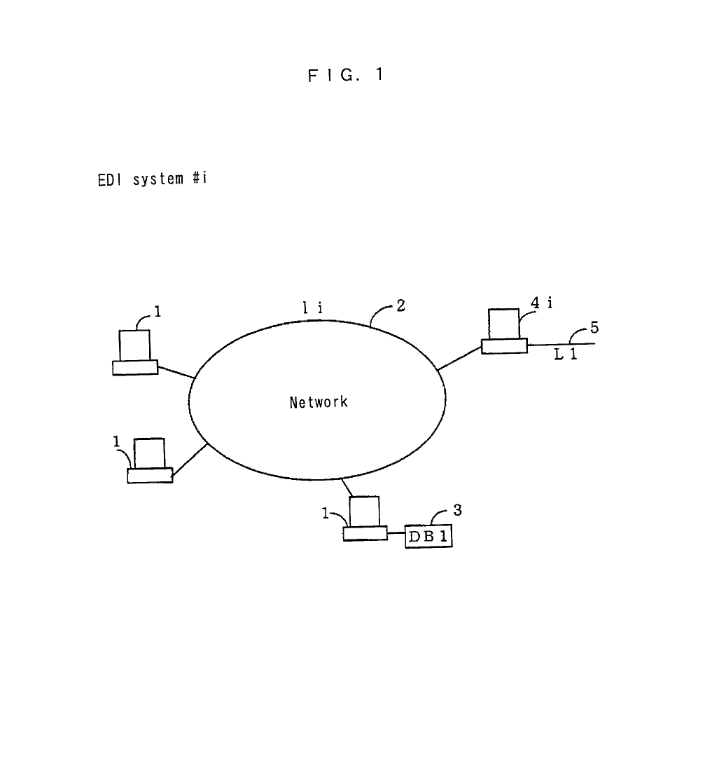

An embodiment of the present invention is described with reference to the drawings in the following. Here, an example of an information publicizing system for publicizing necessary data out of data of EDI systems which have been built and operated by each company is described. FIG. 1 shows an example of the composition of an EDI system. In FIG. 1, the composition of an EDI system #i operated by a company is shown. In the EDI system #i, data for a specific purpose is transferred between terminals 1 through a network 2 and data processing as an EDI system is performed. Reference number 1 is a terminal computer and number 2 is a network, which is here represented by 1i. Number 3 is a storage for storing data utilized in the network 2 in it, said storage containing a database DB1. The database DB1 may be a relational database (RDB) or may be an ordinary database in a simple file form. Number 4i is a coupler, which is provided between 1i being a network 2 and L1 being a data highway network 5 described later. The coupler 4i has a function of sending out data related to the EDI system #1 collected from terminals 1 or the database 3 through the network 2 to the network 5 or sending out data from the network 5 to the network 2. This is further described later.

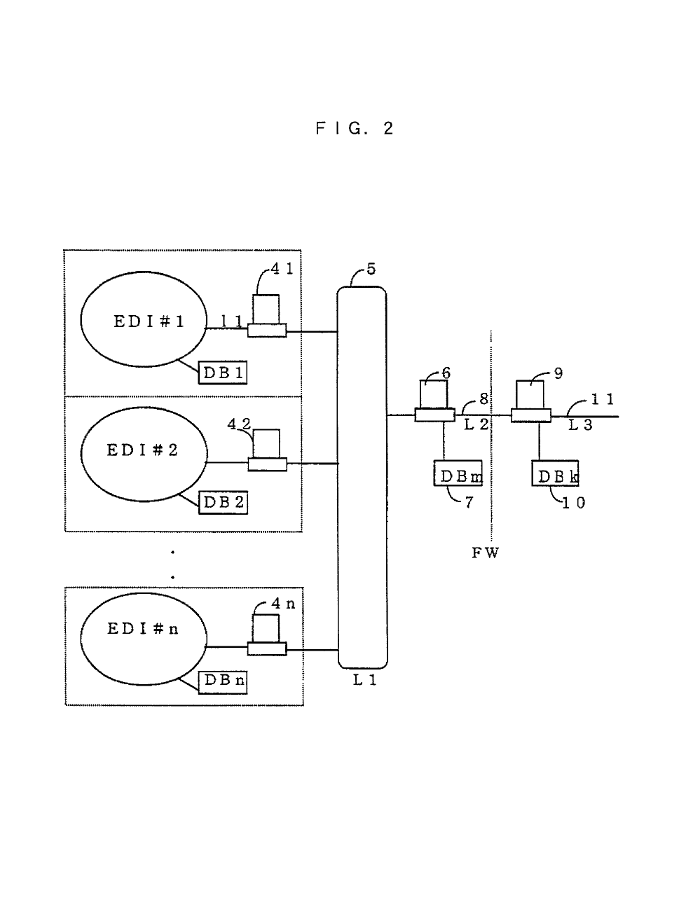

FIG. 2 shows an example of the whole composition of an information publicizing system for publicizing data of various EDI systems. FIG. 2 shows an example in which EDI systems as shown in FIG. 1 are n in number. More concretely, EDI systems #1, #2, . . . ,#n are connected to a network 5 being a data highway respectively through couplers 41, 42, . . . ,4n. The EDI systems have respectively databases DB1, DB2, . . . ,DBn. Here, for simplification, the EDI systems are shown as being similar in composition, but they may be entirely different in composition from one another. Further, one coupler may be provided for a plurality of EDI systems instead of one EDI system.

And the data highway 5 has a publicizing management system 6 connected with it. This publicizing management system 6 is also a computer, which has a storage 7 for storing data in it. The storage 7 contains a database DBm. The database DBm may be a relational database or may be an ordinary database in a simple file form.

And the publicizing management system 6 is connected to a data providing and publicizing system 9 through a communication line L2 denoted by number 8. Number 8 may be a network line.

The data providing and publicizing system 9 is also a computer, which has a storage 10 for storing data in it. The storage 10 contains a database DBk. The database DBk may be a relational database or may be an ordinary database in a simple file form.

And the data providing and publicizing system 9 is connected to a communication line L3 denoted by number 11. Here, the communication line L3 is an Internet line and contents of the database DBk are opened to anyone or particular members through the Internet. The communication line L3 may be a communication line for distributing individual data or may be a communication line for sending data to a predetermined destination. For security of a computer system, a so-called firewall (FW) is formed between the computers 6 and 9. This prevents various malicious invasions through the Internet and the like.

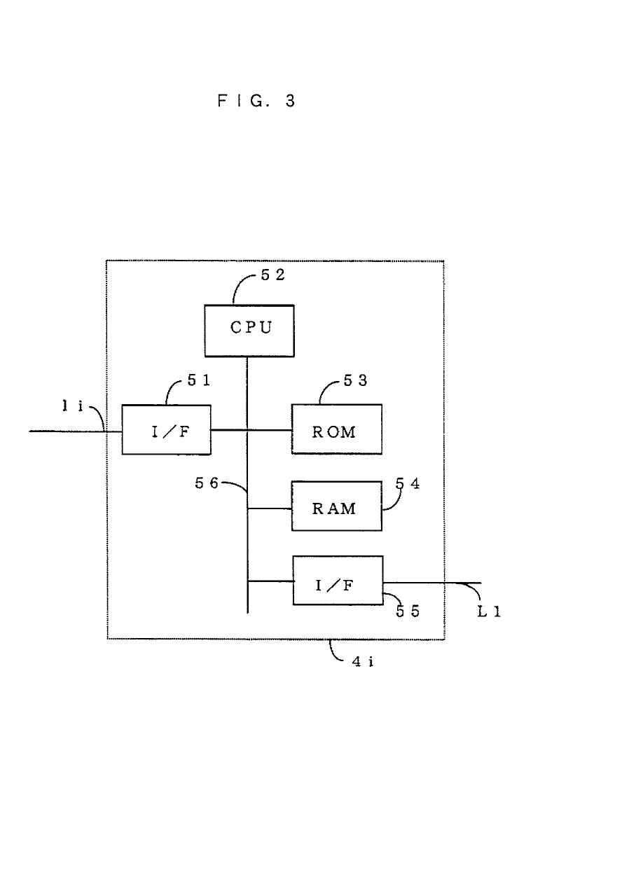

FIG. 3 shows the composition of a coupler 4i. Number 51 is an interface portion for connecting the coupler 4i to a network 1i, number 52 is a CPU (central processing unit), number 53 is a ROM (read-only memory), number 54 is a RAM (random-access memory), and number 55 is an interface portion for connecting the coupler 4i to a data highway L1. These are connected to one another through an internal bus 56.

The coupler 4i has a program built in it for performing functions described in the following, and performs the functions by reading this program from the ROM 53 and reading necessary data from the RAM 54.

The coupler 4i has as one of its functions a function of taking and collecting predetermined data from a terminal 1 or a database DBi through a network 1i, converting the data into data of a predetermined data form (format), and transmitting them to the publicizing management system 6 through a network L1 being a data highway. It has as another function a function of transmitting to a predetermined terminal 1 or writing into a database DBi data or messages obtained through the network L1 from the publicizing management system 6. These functions may be performed periodically according to a schedule or condition programmed in the coupler 4i, or may be performed in response to a request from a terminal 1 or the publicizing management system 6. Further, it has also a function of transferring data between EDI systems. This is utilized in case of transferring predetermined data between EDI systems and utilizing the data in both of the EDI systems.

The publicizing management system 6 is also a computer and since its composition is the same as an ordinary computer, description of its content and composition is omitted. This has a function of determining contents of data to be publicized in the data providing and publicizing system 9 and automatically collecting or generating data to be distributed.

For example, in case of opening data to the public through the Internet, kinds of data and screen formats of the data are determined in advance, and they are concretely determined by design of a screen frame to be publicized. If data to be publicized on a screen is data obtained by processing data from an EDI system, a program for performing such processing operations is incorporated and executed in the publicizing management system 6. The results of processing operations are written into the storage 7 as secondary processed data #1, #2, etc. of DBm. Data to be publicized are produced utilizing individual EDI data #1, #2, etc. to be described later and secondary processed data #1, #2, etc., and are stored in specified regions in the storage 7 as data to be publicized A, B, etc.

And when data to be publicized are to be updated is also determined in advance. This is determined according to the time of collecting data in a data collecting program for collecting data to be the original data for data to be publicized. The time of collecting data varies depending upon whether the time of collecting and writing data into the storage 7 of the publicizing management system 6 through the network 5 from a coupler 4 is determined by a periodical schedule or by occurrence of an event caused by satisfaction of a specified condition.

Since data to be publicized are not generated until collected data are processed into the data to be publicized, the time of publicizing is determined in consideration of a time necessary for a process including a data collection and an operation process.

The data providing and publicizing system 9 is also a computer and since the composition of it is the same as an ordinary computer, description of its content and composition is omitted. Here, it is connected to an Internet line and has a function of publicizing contents of the publicized database DBk in response to an access to the Internet.

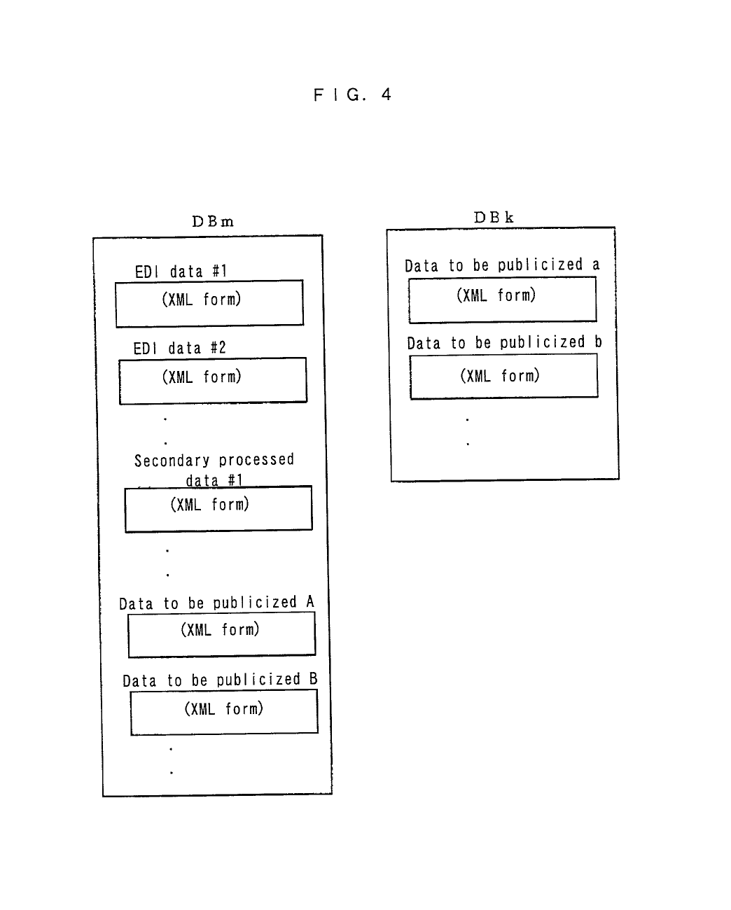

FIG. 4 shows schematically contents of the databases DBm and DBk. The database DBm has individual EDI data #1, #2, . . . ,#n being data obtained by converting data obtained from the respective EDI systems into data of a predetermined common form. Here, a form of XML (extensible Markup Language) is used as a common form. Collected data are converted into data having a form of XML and stored into the DBm.

The database DBm further has secondary processed data #1, #2, etc. being data obtained by secondarily processing and converting individual EDI data and the like into data of a common form. The secondary processed data may be data processed on the basis of a plurality of individual EDI data or may be data obtained by processing individual EDI data together with data kept by the publicizing management system 6.

Furthermore, the database DBm has also data to be publicized A, B, etc. These are data generated on the basis of individual EDI data #1, #2, etc. and secondary processed data #1, #2, etc., and these are also in a form of XML. They are the same as data publicized by the data providing and publicizing system 9.

And the database DBk stored in the storage 10 of the data providing and publicizing system 9 has data to be publicized a, data to be publicized b, etc. These are data obtained by copying the data to be publicized A, B, etc. of the storage 7 of the publicizing management system 6. Therefore, these are also data being in a form of XML. Here, the data providing and publicizing system 9 is a server system used in the Internet, and these data to be publicized a, b, etc. can be seen by a person accessing them through the Internet.

Next, the present invention is described by way of an example utilizing this system to automatically publicize excess articles data. Primary products such as steel materials, chemicals and the like are manufactured and sold through EDI systems built by the respective manufacturer systems, trading company systems and the like. However, some excess products occur due to errors in estimation of demand and the like. In such a case a manufacturer has some excess products as stock and wants to sell the excess products in order to reduce their stock expenses, but needs a business burden heavier than a regular management for dealing with them. Thereupon, the present invention can be applied to inviting customers by publicizing excess articles from the EDI systems of the respective systems on a Web site of the Internet.

Each EDI system makes a coupler 4 connected to its own network collect excess articles data. It may make a program in each coupler 4 collect automatically the data as described above, or may make individual terminals 1 send the data to each coupler 4. Each coupler 4 converts the excess articles data into data having a form of XML used as a common form and sends them to the publicizing management system 6. The publicizing management system 6 makes an operator judge whether or not the collected excess articles data may be publicized and processes the excess articles data through adding hints to customers for publication to produce data to be publicized. The data to be publicized may be automatically produced by means of design of screens for publication. The data to be publicized which have been determined by the publicizing management system 6 are sent to the data providing and publicizing system 9 to be publicized through the Internet and are publicized.

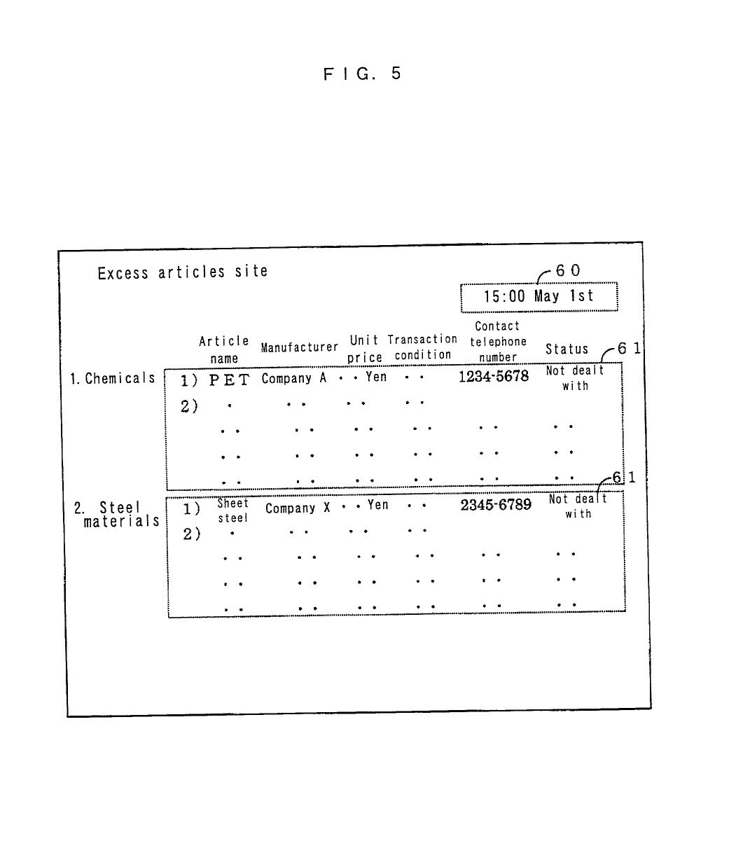

FIG. 5 shows an example of excess articles site screens. The screen has a date and time data field 60 for showing what point of time there are excess articles at and data fields 61 each of which shows the name, manufacturer, unit price, condition of transaction, contact telephone number, status and the like of each excess article for each category. As data of these displayed excess articles, data obtained from data in an EDI system are used as they are, or data obtained by partially processing or adding the obtained data are used.

Excess articles are publicized on the Internet in such a way. A person looking at them and hoping to purchase an article makes a call to its contact telephone number to tell a contact person the intention of purchase. Or a customer may be made to input data on the Web screen, and in this case the inputted purchase information is recorded in the publicizing management system 6. A coupler 4 of the corresponding EDI system or the corresponding terminal 1 through a coupler is notified of a fact that the inputted purchase information has been recorded and the recorded content by a program recorded in advance in the publicizing management system. Looking at the notification, it is determined whether or not the article is to be sold. An electronic mail on the Internet or other means may be used for notifying of a process after the determination.

As described above, excess articles occurring in each EDI system can be opened to general people or particular members as sale information.

Next, an example of an information publicizing site at the time of a disaster is described. At the time of a natural disaster such as an earthquake, a tidal wave, a volcanic eruption and the like, it is necessary to quickly open various information to the public. A person concerned, who wants to know the latest information at any time, must collect information related to roads such as a state of unavailability, a recovery prospect and the like from a road information system, and must collect railroad information from a railroad information center. In addition, it has not been easy to collect information in such cases that information of an administrative organ of the district must be collected from a Web system and the like through which the district administrative organ issues information, information of a missing person must be collected from an information center related to the police, and information of a hospital hospitalizing an injured person must be collected from an information center related to an emergency and fire defense organ. Thereupon, it is convenient to a user that every information concerned is publicized at one place (or a few places).

The present invention can be also applied to a case of collectively publicizing information separately managed in such a way. Data which various administrative organs and the like possess on their respective systems are collected by the above-mentioned couplers, are converted into data of a common data format and are transmitted to the publicizing management system 6 through a network. The transmitted data in the common format are stored into the storage 7 of the publicizing management system 6. A necessary process is applied to the stored data to form data to be publicized. Particularly, at the time of a disaster, when and in what form and in what expression data should be opened to the public are sufficiently examined, and therefore in a publicizing management system an operator judges whether or not data should be opened to the public and finally the contents of data to be publicized and messages related to those data are determined.

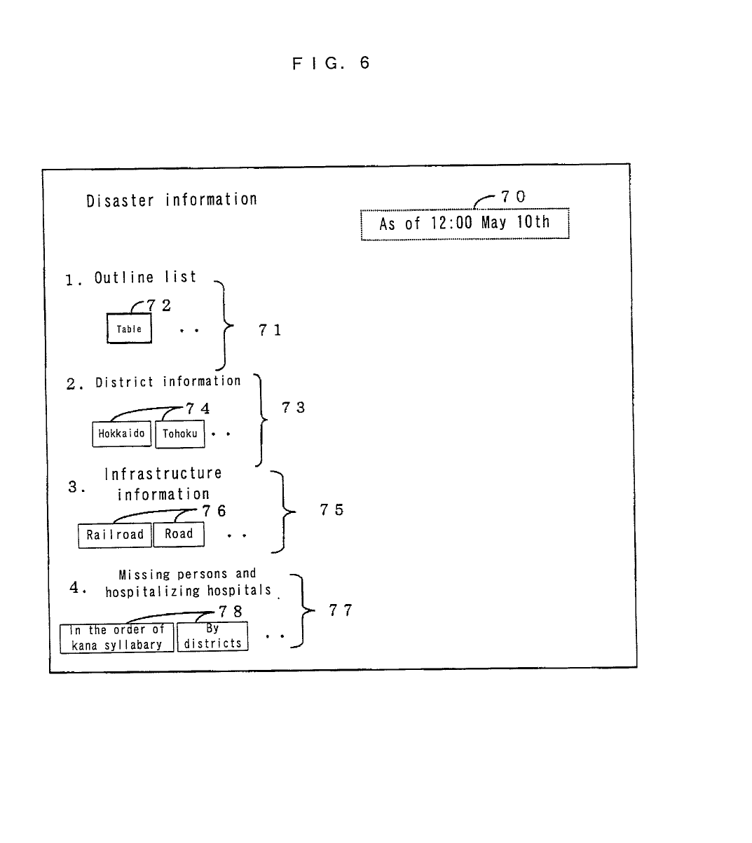

FIG. 6 shows a screen example of a disaster information site. This screen has a date and time data field 70 for showing the point of time of the displayed disaster information and a disaster outline list field 71 obtained by arranging an outline of a disaster to be displayed in this site in a list form. This screen is changed over into a screen (not illustrated) in which a list is displayed in the form of a table by clicking a button 72 in the field 71. And it has a district information field 73 for showing data by districts, and clicking a district button corresponding to a district such as Hokkaido, Tohoku or the like changes over the displayed screen into a screen (not illustrated) displaying disaster information of the clicked district. And it has an infrastructure field 75 as fields by infrastructures, and clicking an infrastructure button corresponding to railroad, road, etc. changes over the displayed screen into a screen displaying data of the clicked infrastructure. Further, it has also a missing person or hospitalized person information field, and clicking a corresponding button changes over the displayed screen into a screen (not illustrated) displaying data corresponding to this button.

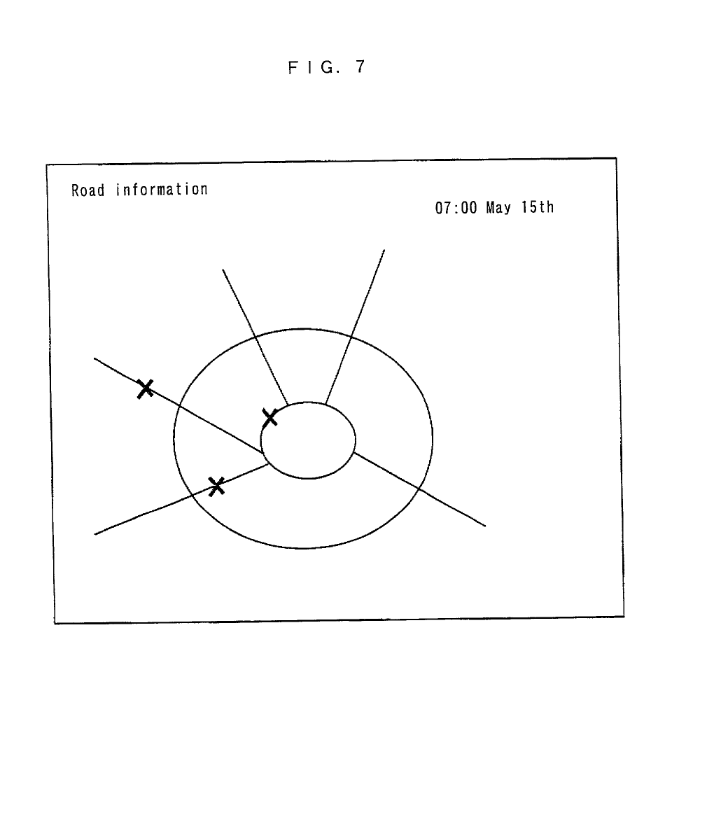

FIG. 7 shows an example of a screen changed over by clicking a road information button. A road diagram is schematically displayed on the screen, and a place being in an impassable state at a date and hour shown at the upper right part of the screen is indicated by “mark X”. Further, clicking a place marked X displays a screen (not illustrated) showing the cause of impassability, its recovery schedule and the like.

Data concerned in roads are also displayed on the basis of data obtained from a system processing data related to roads, but all data are not displayed but what data should be publicized and how the data should be displayed are determined and then they are publicized.

In FIG. 2, each of the respective EDI systems is a system dealing with its own information, and the publicizing management system collects data from those systems through the couplers 4, arranges necessary data and publicizes them through the data providing and publicizing system.

Describing more in detail, data in the disaster outline list field 71 shown in FIG. 6 are displayed on the basis of data obtained by processing data taken from a government-related system. Similarly, the district information field 73 utilizes data from systems of administrative organs of the metropolis and districts (To, Do, Fu and Prefectures), and cities, towns and villages and the like. The infrastructure field 75 utilizes data from organs concerned in administrative organs administering railroads, roads and the like. Further, data of missing persons or hospitalized persons are formed into data to be publicized by utilizing data from systems of police stations or hospitals.

In such a way, data respectively obtained from different systems are converted into data of a common form, for example, a form of XML through couplers 4 connected to the systems or networks and are stored into the storage 7 of the publicizing management system 6. And a necessary processing operation is applied to the data to produce data to be publicized, and the data to be publicized are stored into the storage 10 of the data providing and publicizing system 9 for publicizing to come to be capable of being publicized. Thanks to this, since data from various systems can be collectively and quickly publicized at the time of a disaster, information at the time of a disaster can be properly publicized.

As described above, the present invention can be applied to not only publicizing data of general EDI systems among companies but also publicizing information for transaction of excess articles of primary products of steel, plastics and the like, or industrial products, publicizing various information for crisis management at the time of a disaster or the like, publicizing talent information, and publicizing other various information.

And it is a matter of course that an object of the present invention can be attained also by supplying a program code (including its execution form) of a software program for realizing functions of a terminal or device according to the above-mentioned embodiment to a system or apparatus by means of a storage medium recording the whole or a part of the program code on it, making a computer (or CPU, MPU) of the system or apparatus read the program code stored in the storage medium, and performing the whole or a part of its operation.

In this case the program code itself read out from the storage medium comes to realize the functions of this embodiment, and the storage medium storing the program code in it results in composing the present invention.

As a storage medium for supplying a program code, it is possible to use a ROM, floppy disk, hard disk, optical disk, magneto-optic disk, CD-ROM, CD-R, magnetic tape, nonvolatile memory card and the like. Further, a program code may be supplied by being downloaded through a communication circuit, and a program can be supplied and executed by utilizing a technique of JAVA and the like.

And it is a matter of course that the present invention includes not only a case that the functions of this embodiment are realized by executing a program code read by a computer but also a case that an OS or the like running on a computer performs a part or the whole of an actual process on the basis of instructions of the program code and thereby the functions of this embodiment are realized.

Furthermore, it is a matter of course that the present invention includes also a case that a program code read out from a storage medium is written into a memory provided on a function extending board inserted into a computer or a function extending unit connected to a computer and thereafter a CPU or the like provided in the function extending board or the function extending unit performs a part or the whole of an actual process on the basis of instructions of the program code and the functions of this embodiment are realized by this process.

Additionally, the present invention may be a program product including a program for making a computer perform each step of claim 4, 5 or 6. Here, a program product includes not only a computer program but also a storage medium or a computer recording the program in it.

As described above, according to the present invention, it is possible to provide an information publicizing system and an information publicizing method capable of collectively and quickly publicizing data related to various systems or network systems and data of messages and the like related to those data.

What is claimed is:

1. An information publicizing system comprising couplers respectively connected to systems each of which processes data for its purpose and a publicizing management system which is connected to said couplers and keeps data to be publicized, wherein;
said couplers have means for converting data dealt with in said respective systems into data of a specified common form and means for sending the converted data to said publicizing management system, and
said publicizing management system has a means for producing data to be publicized on the basis of the received data.

2. An information publicizing system according to claim 1, wherein;
data to be publicized of said publicizing management system are publicized in a system capable of being accessed through the Internet.

3. An information publicizing system according to claim 1, wherein;
data to be publicized of said publicizing management system are transmitted to a predetermined destination through a communication line.

4. An information publicizing method for publicizing data of a plurality of systems processing data for their respective purposes, said method comprising;
a step of converting data dealt with in said respective systems into data of a specified common form in couplers connected to the respective systems,
a step of transmitting the converted data to a publicizing management system, and
a step of making said publicizing management system produce data to be publicized on the basis of the received data and publicizing the produced data to be publicized.

5. An information publicizing method according to claim 4, wherein;
data to be publicized of said publicizing management system are publicized in a system capable of being accessed through the Internet.

6. An information publicizing method according to claim 4, wherein;
data to be publicized of said publicizing management system are transmitted to a predetermined destination through a communication line and are publicized.

7. A computer-readable recording medium recording in it a program for making a computer perform the respective steps described in claim 4.

8. A computer-readable recording medium recording in it a program for making a computer perform the respective steps described in claim 5.

9. A computer-readable recording medium recording in it a program for making a computer perform the respective steps described in claim 6.

10. A program product for making a computer perform the respective steps described in claim 4.

11. A program product for making a computer perform the respective steps described in claim 5.

12. A program product for making a computer perform the respective steps described in claim 6.
